(19) United States
(12) Patent Application Publication
(10) Pub. No.: US 2007/0162446 A1
(43) Pub. Date: Jul. 12, 2007

(54) METHOD OF TESTING A MULTI-PROCESSOR UNIT MICROPROCESSOR

(76) Inventors: David Peter Appenzeller, Essex Junction, VT (US); Frances Samantha Mary Clougherty, Essex Junction, VT (US); James Joseph Garris, Richmond, VT (US); Kort Foster Longenbach, Williston, VT (US); Bruce George Ogilvie, Shelburne, VT (US); Dean Guy Percy, Stowe, VT (US); Norman Jay Rohrer, Underhill, VT (US); William J. Tanona, Colchester, VT (US); Mario Theberge, Granby (CA); Jin Jwang Wu, Essex Junction, VT (US)

Correspondence Address: SCHMEISER, OLSEN & WATTS, 22 CENTURY HILL DRIVE, SUITE 302, LATHAM, NY, 12110, US

(21) Appl. No.: 11/275,533

(22) Filed: Jan. 12, 2006

(51) Int. Cl. G06F 17/30

(52) U.S. Cl. 707/7

(57) ABSTRACT

A method of testing a multi-processor unit microprocessor. The method includes: (a) selecting and testing, with a selected parameter set of a group of parameter sets, a processor unit of a microprocessor having two or more processor units; (b) comparing the operation of the selected processor unit to a selected specification of a set of operational specifications of the microprocessor; (c) if the testing indicates that the operation of the selected processor unit does not meet the selected specification, repeating (a) and (b) with a different parameter set of the group of parameter sets until either the selected processor unit meets the selected specification or all parameter sets of the group of parameter sets have been selected; and (d) if the operation of the selected processor unit does meet the selected specification, repeating (a), (b) and (c) until all processor units have been selected.

### FIELD OF THE INVENTION

The present invention relates to the field of multi-processor unit microprocessors; more specifically, it relates to a method of testing and sorting multi-processor unit microprocessors and specifying performance and resource requirements for each processing unit of multi-processor unit microprocessors.

### BACKGROUND OF THE INVENTION

Microprocessors are tested and sorted to specific operating specifications such as frequency and power. Large multi-processor unit microprocessors often can not meet a common optimal specification due to, for example, process variations across the integrated circuit chip. In one example, process variations cause one portion of the microprocessor to run slow, but to consume less power than an another portion which runs faster but consumes more power. This leads to a specification on the entire microprocessor of the speed of the slower region, but at the cost of a faster region consuming more power than is desirable in a speed/power optimized microprocessor. In such a case, the microprocessor has less market value. Further, regions running different power levels generate non-uniform heating for which it is more difficult to provide a cooling solution.

Therefore, there is a need for a method to guarantee that a microprocessor's performance and heating are as uniform as possible across the integrated circuit chip.

### SUMMARY OF THE INVENTION

A first aspect of the present invention is a method, comprising: (a) selecting and testing, with a selected parameter set of a group of parameter sets, a processor unit of a microprocessor having two or more processor units; (b) comparing the operation of the selected processor unit to a selected specification of a set of operational specifications of the microprocessor; (c) if the testing indicates that the operation of the selected processor unit does not meet the selected specification, repeating (a) and (b) with a different parameter set of the group of parameter sets until either the selected processor unit meets the selected specification or all parameter sets of the group of parameter sets have been selected; and (d) if the operation of the selected processor unit does meet the selected specification, repeating (a), (b) and (c) until all processor units of the two or more processor units of the microprocessor have been selected.

A second aspect of the present invention is a computer program product, comprising a computer usable medium having a computer readable program code embodied therein, the computer readable program code comprising an algorithm adapted to implement a method for testing and sorting a microprocessor having two or more processor units, the method comprising the steps of: (a) selecting and testing, with a selected parameter set of a group of parameter sets, a processor unit of a microprocessor having two or more processor units; (b) comparing the operation of the selected processor unit to a selected specification of a set of operational specifications of the microprocessor; (c) if the testing indicates that the operation of the selected processor unit does not meet the selected specification, repeating (a) and (b) with a different parameter set of the group of parameter sets until either the selected processor unit meets the selected specification or all parameter sets of the group of parameter sets have been selected; and (d) if the operation of the selected processor unit does meet the selected specification, repeating (a), (b) and (c) until all processor units of the two or more processor units of the microprocessor have been selected.

A third aspect of the present invention is a microprocessor, comprising: two or more processor units, each processor unit comprising a voltage island; and a fuse bank in the microprocessor, the fuse bank encoding, independently for each processor unit of the two or more processor units, at least one operating parameter for each of the processor units of the two or more processor units.

### BRIEF DESCRIPTION OF DRAWINGS

The features of the invention are set forth in the appended claims. The invention itself, however, will be best understood by reference to the following detailed description of an illustrative embodiment when read in conjunction with the accompanying drawings, wherein:

FIG. 1A is a plan view of a microprocessor having two processor units according embodiments of the present invention;

FIG. 1B is a plan view of a microprocessor having four processor units according embodiments of the present invention;

FIG. 2 is a schematic diagram of a power distribution network 250 for a dual-processor unit microprocessor where each processor unit is a voltage island according to embodiments of the present invention;

FIG. 3A is a flow diagram of a first method of testing an multi-processor unit microprocessor;

FIG. 3B is a flow diagram of a second method of testing a multi-processor unit microprocessor;

FIGS. 4A and 4B are a flow diagram of a third method of testing a multi-processor unit microprocessor;

FIG. 5 is a flow diagram of a fourth method of testing a multi-processor unit microprocessor; and

FIG. 6 is a schematic block diagram of a general-purpose computer portion of a tester for practicing the present invention.

### DETAILED DESCRIPTION OF THE INVENTION

For the purposes of the present invention the term processor unit denotes a completely functional microprocessor. Processor units are also known as processor cores or microprocessor cores. To avoid confusion, though processor units are microprocessors two conventions may be used. In the first convention the term microprocessor is used to describe an electronic device implemented as an integrated circuit chip and having multiple processor units in different regions of the same integrated circuit chip. In the second convention the term microprocessor is used to describe an electronic device implemented as a multi-chip module (MCM) and having multiple processor units, each processor unit on different integrated circuit chips of the MCM. The embodiments of the present invention are described in terms of the first convention (a single integrated circuit chip), but may be applied to the second convention as well (an MCM).

For the purposes of the present invention the term voltage island denotes a bounded region of an integrated circuit chip having an internal power distribution network that is supplied from a power source external to that region. Different voltage islands may be supplied from a same power supply or from different power supplies. Voltage islands may include fencing circuits for communication across voltage island boundaries. Voltage islands are also known as voltage domains.

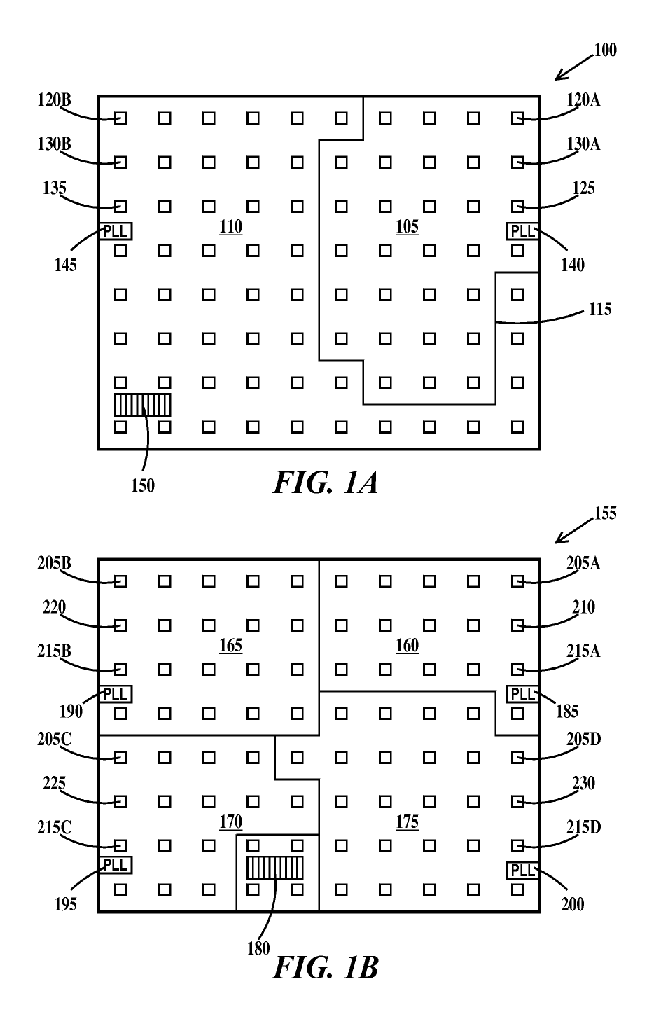

FIG. 1A is a plan view of a microprocessor 100 having two processor units according embodiments of the present invention. In FIG. 1A, microprocessor 100 includes a first processor unit (PU) 105 and a second processor unit 110. Processor units 105 and 110 are separated from each other by a boundary 115. In one embodiment, processor units 105 and 110 are also voltage islands which are separated from each other by boundary 115. Processor unit 105 includes a multiplicity of I/O pads 120A, a multiplicity of power pads 125 and a multiplicity of ground pads 130A. Processor unit 110 includes a multiplicity of I/O pads 120B, a multiplicity of power pads 135 and a multiplicity of ground pads 130B.

Power pads 125 and 135 supply power to respective processor units 105 and 110 from one or two external power supplies. In the event of two external power supplies, then all power pads 125 are supplied from a first external power supply and all power pads 135 are supplied from a second external power supply. In the event of two external power supplies, the external power supplies may have the same VDD level or different VDD levels as described infra. Though, generally ground (GND or VSS) of both power supplies are connected externally and all ground pads 130A and 130B are connected to the common ground, it is possible to have separate grounds from each power supply, (which may have the same or different voltage levels), the ground of the first external power supply connected to all grounds pads 130A and the ground of the second external power supply connected to all ground pads 130B.

In one embodiment, processor units 105 and 110 are also clock domains which are separated from each other by boundary 115. This may be implemented several ways:

First processor unit may include an optional first clock generating circuit (in one example a phase-lock-loop (PLL)) 140 that generates the clock signal that defines the operating frequency of first processor unit 105, and second processor unit 110 may include an optional second clock generating circuit (in one example a PLL) 145. Clock generating circuits 140 and 145 may have a same frequency or different frequencies.

Clock signals may be supplied from two external clock circuits through corresponding I/O pads 120A and 120B of each processor unit 105 and 110. The external clock circuits may have a same frequency or different frequencies.

In one embodiment, only one clock generating circuit is present and is in a third voltage island different from that of first and second processor units 105 and 110.

In one embodiment, microprocessor 100 includes an optional fuse bank and support circuit 150 that may be used, for example, to encode operational specifications/information general to microprocessor 100 as well as specific to processor units 105 and 11O. Such information may include operating voltage and operating frequency. While fuse bank and support circuit 150 are illustrated in second processor unit 110, there may be an additional fuse bank located in first processor unit 105 or fuse bank and support circuit 150 may be located in another, non-processor unit region of microprocessor 100 including a third or fourth voltage island.

While only a small number of pads are illustrated in FIG. 1, in one example there may be 350 or more of each of power pads 125, ground pads 130A, ground pads 130B, and power pads 135, and 200 or more of I/O pads 120A and 120B arranged in an array of pads.

FIG. 1B is a plan view of a microprocessor having four processor units according embodiments of the present invention. In FIG. 1B, a microprocessor 155 is similar to microprocessor 100 of FIG. 1A and includes a first processor unit 160, a second processor unit 165, a third processor unit 170 and a fourth processor unit 175. Processor units 160, 165, 170 and 175 are also voltage islands. Processor unit 165 includes a multiplicity of I/O pads 205A, a multiplicity of power pads 210, a multiplicity of ground pads 215A and optional clock generating circuit (in one example a PLL) 185. Processor unit 165 includes a multiplicity of I/O pads 205B, a multiplicity of power pads 220, a multiplicity of ground pads 215B and an optional clock generating circuit (in one example a PLL) 190. Processor unit 170 includes a multiplicity of I/O pads 205C, a multiplicity of power pads 225, a multiplicity of ground pads 215C and optional clock generating circuit (in one example a PLL) 195. Processor unit 175 includes a multiplicity of I/O pads 205D, a multiplicity of power pads 230 and a multiplicity of ground pads 215D and an optional clock generating circuit (in one example a PLL) 200.

In FIG. 1B, a fuse bank and support circuit 180 is in a non-processor region of microprocessor 170. Fuse bank and support circuit 180 may be in its own voltage island or share the voltage island of a processor unit, for example that of third processor unit 170.

Microprocessor 100 of FIG. 1A and microprocessor 170 of FIG. 1B are exemplary of microprocessors according to embodiments of the present invention which have two or more processing units that are also voltage islands, clock domains or both voltage islands and clock domains.

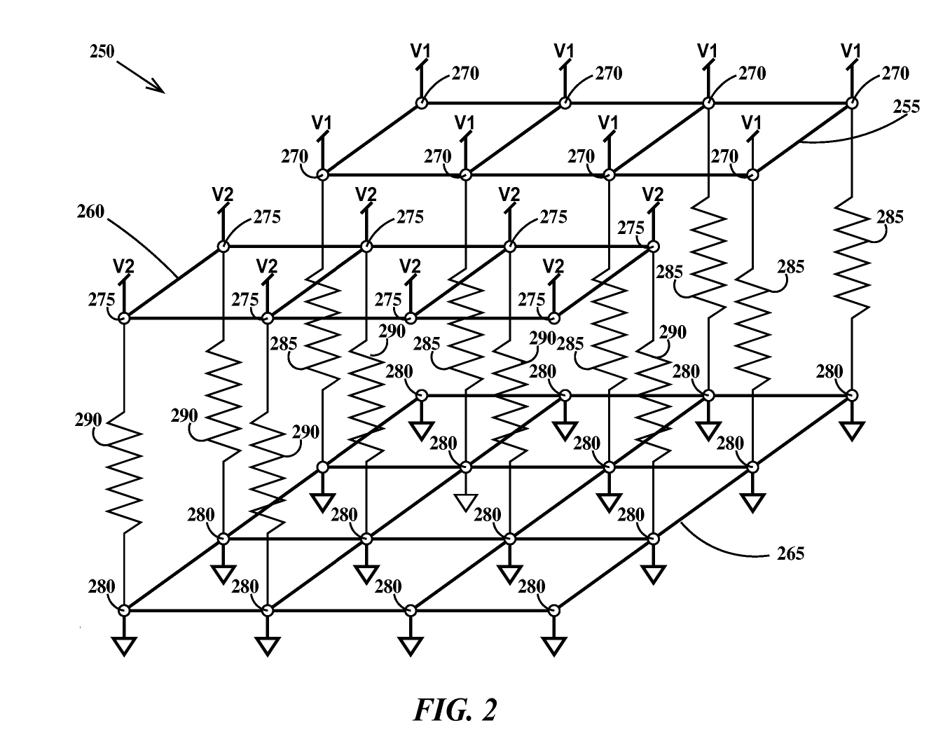

FIG. 2 is a schematic diagram of a power distribution network 250 for a dual-processor unit microprocessor where each processor unit is a voltage island according to embodiments of the present invention. In FIG. 2, power distribution network 250 includes a first power grid 255, a second power grid 260 and a ground grid 265. Each of a multiplicity of nodes 270 of power grid 255 are connected to a first terminal V1 of a first external power supply through a multiplicity of power pads (see FIG. 1A). Each of a multiplicity of nodes 275 of power grid 260 are connected to a first terminal V2 of a second external power supply through a multiplicity of power pads (see FIG. 1A). Each of a multiplicity of nodes 280 of ground grid 265 are connected to a common ground terminal of both first and second external power supplies through a multiplicity of ground pads (see FIG. 1A).

Power grid 255 and ground grid 265 comprise a first voltage island. Power grid 260 and ground grid 265 comprise a second voltage island. Connected between power grid 255 and ground grid 265 are the circuits of a first processor unit (see FIG. 1A) represented by loads 285 (which are illustrated as resistive, but may be capacitive, inductive or a combination of resistive, capacitive and inductive loads). Connected between power grid 260 and ground grid 265 are the circuits of a second processor unit (see FIG. 1A) represented by loads 290 (which are illustrated as resistive, but may be capacitive, inductive or a combination of resistive, capacitive and inductive loads).

Power grid 255 is electrically and physically part of a first processor unit. Power grid 260 is electrically and physically part of a second processor unit. Ground grid 265 is physically shared between the first and second processor units. Alternatively, ground grid 265 may be split into two electrically separate ground grids, a first ground grid physically located in the first processor unit and a second ground grid physically located in the second processor unit.

In a similar manner to power distribution network 250, a clock domain network may be illustrated with power grids 255 and 260 replaced by clock trees, which may be grid-like in structure or comprised of a set of cascaded spoke-like distribution nodes.

All methods of testing and sorting microprocessors according to embodiments of the present invention are performed after functional test has been performed and the microprocessor is functionally “good.” Microprocessors that do not pass functional test are discarded and are not sorted.

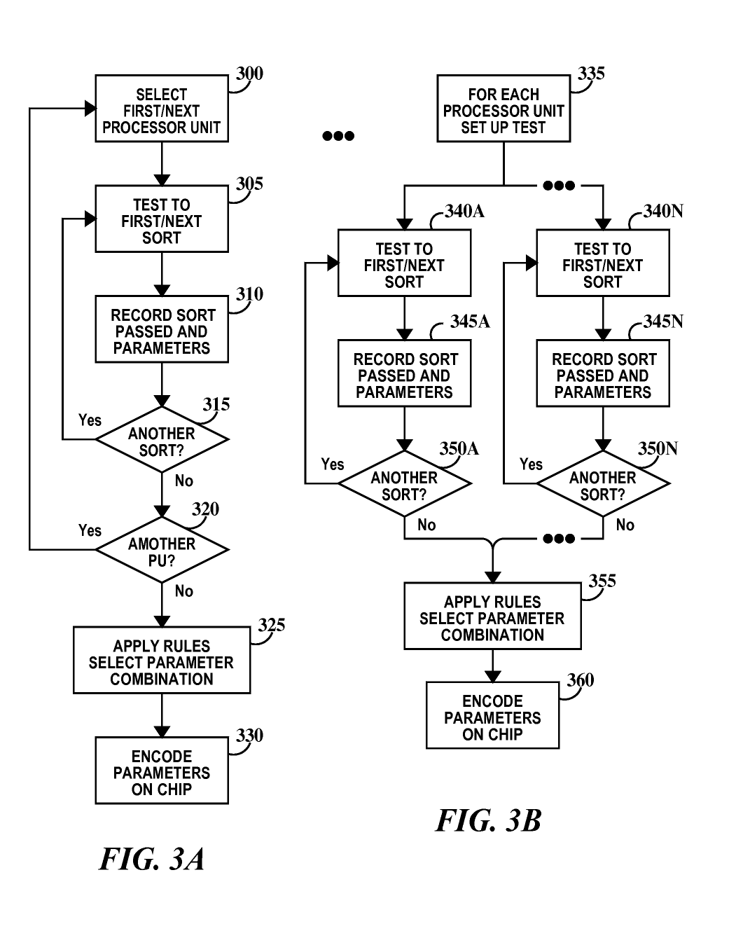

FIG. 3A is a flow diagram of a first method of testing a multi-processor unit microprocessor. In step 300, the first/next processor unit is selected for testing. In step 305, the selected processor unit is tested to the first/next sort specification.

A sort specification is a set of specified parameters that for a given processor unit must occur and be satisfied together. A sort test includes the same parameters as its corresponding sort specification, except some parameters are supplied by the tester and some are measured by the tester. For example, a voltage level may be supplied and operating frequency, power consumption and temperature measured. A general example of a sort test is a specification stating a power requirement of the processor unit at a given operating frequency and operating temperature. Since power is current (I) times voltage (V) or IV, operating voltage is a parameter as well. Any given sort may include a range of one or more of the specified parameters. Sorts according the embodiments of the present invention include, but are not limited to holding power, operating frequency and temperature constant at different voltages (to control power consumption); and holding voltage, power and temperature constant at different frequencies (to control performance). Table I gives some exemplary sort tests.

TABLE

| | TEMP | POWER | FREQ | VOLTS |
|---|---|---|---|---|
| SORT 1 | 85° C. | 90 W | 2.56 GHz | 1.05 V |
| | 85° C. | 90 W | 2.56 GHz | 1.15 V |
| | 85° C. | 90 W | 2.56 GHz | 1.25 V |
| SORT 2 | 85° C. | 100 W | 2.56 GHz | 1.05 V |
| | 85° C. | 100 W | 2.56 GHz | 1.15 V |
| | 85° C. | 100 W | 2.56 GHz | 1.25 V |
| SORT 3 | 85° C. | 110 W | 2.56 GHz | 1.05 V |
| | 85° C. | 110 W | 2.56 GHz | 1.15 V |
| | 85° C. | 110 W | 2.56 GHz | 1.25 V |
| SORT 4 | 85° C. | 100 W | 2.56 GHz | 1.05 V |
| | 85° C. | 100 W | 2.46 GHz | 1.05 V |
| | 85° C. | 100 W | 2.36 GHz | 1.05 V |
| SORT 5 | 85° C. | 100 W | 2.56 GHz | 1.15 V |
| | 85° C. | 100 W | 2.46 GHz | 1.15 V |
| | 85° C. | 100 W | 2.36 GHz | 1.15 V |
| SORT 6 | 85° C. | 100 W | 2.56 GHz | 1.25 V |
| | 85° C. | 100 W | 2.46 GHz | 1.25 V |
| | 85° C. | 100 W | 2.36 GHz | 1.25 V |

In all tables, “W” is watts and “V” is volts. While Table I, shows only one parameter being varied in each sort, it is possible to vary two or more parameters within a sort. Also, while Table 1 shows only three sets of parameters in each sort, there may be any number of parameter combinations within a sort. Also, to pass a specific parameter, the test result need not be exactly the value listed in Table I, but within a range. For example the 100 W specification may be passed if the processor unit is between 95 W and 105 W.

In step 310, all the combinations of tests of each test that the current processor unit passes are recorded as illustrated in Table II infra. Next, in step 315, it is determined if there is another sort test to be performed, if not the method proceeds to step 320, if there is another sort test to be performed, the method loops back to step 305. In step 315, it is determined if there is another processor unit to be tested, if not the method step 325, if there is another sort test to be performed, the method loops back to step 300. Table II gives some exemplary sort test results.

TABLE II

| PROCESSOR | SORT | TEMP | POWER | FREQ | VOLTS |
|---|---|---|---|---|---|
| PU1 | 1 | 85° C. | 90 W | 2.56 GHz | 1.05 V |
| PU1 | 1 | 85° C. | 90 W | 2.56 GHz | 1.15 V |
| PU1 | 2 | 85° C. | 100 W | 2.56 GHz | 1.15 V |
| PU1 | 3 | 85° C. | 110 W | 2.56 GHz | 1.25 V |
| PU2 | 1 | 85° C. | 90 W | 2.56 GHz | 1.15 V |
| PU2 | 2 | 85° C. | 100 W | 2.56 GHZ | 1.25 V |
| PU2 | 4 | 85° C. | 100 W | 2.56 GHz | 1.05 V |
| PU2 | 4 | 85° C. | 100 W | 2.46 GHz | 1.05 V |
| PU3 | 1 | 85° C. | 90 W | 2.56 GHz | 1.05 V |
| PU3 | 1 | 85° C. | 90 W | 2.56 GHz | 1.15 V |
| PU3 | 2 | 85° C. | 100 W | 2.56 GHz | 1.15 V |
| PU3 | 3 | 85° C. | 110 W | 2.56 GHz | 1.25 V |
| PU4 | 1 | 85° C. | 90 W | 2.56 GHz | 1.15 V |
| PU4 | 2 | 85° C. | 100 W | 2.56 GHz | 1.25 V |

In step 325, a set of selection rules is applied to the information of Table II in order to select a parameter combination for each processor unit that optimizes a goal of the sort testing. For example, the goals of the sort testing may be to have a microprocessor with the maximum performance, lowest power requirement or most uniform heat dissipation across the integrated circuit chip. Table III gives some exemplary rules.

TABLE III

| # | RULE |
|---|---|
| 0 | ALL PU have same TEMP, PWR, FREQ and VDD |
| 1 | ALL PU have same TEMP, PWR and FREQ different VDD |
| 2 | ALL PU have same TEMP and PWR, different FREQ and VDD |
| 3 | ALL PU have same TEMP and FREQ, different PWR and VDD |
| 4 | ALL PU have same TEMP different PWR, FREQ and VDD |

The rules are applied in order and the method stops when a rule is met. Within each rule, there may be a hierarchy of sub-rules. For example, when processor units having different VDD are allowed, there may be a rule indicating a maximum voltage difference between the processor unit having lowest VDD and the processor unit having the highest VDD. In another example, when processors with different FREQ and VDD are allowed, there may be sub-rules indicating whether the closet match in FREQ or PWR is to be selected. Note rule 0, is essentially a perfect microprocessor with all processor units performing to a prime specification.

In optional step 330, codes indicating the parameters for each processor unit are encoded into the fuse bank(s) (see FIGS. 1A and 1B) of the microprocessor. In subsequent module processing or packaging operations, the parameters required for each processor unit may be encoded in fuse banks contained in the microprocessor, if they were not encoded in optional step 330, and/or they may be printed on the microprocessor module.

FIG. 3B is a flow diagram of a second method of testing an multi-processor unit microprocessor. In FIG. 3B, N processor units are assumed. In step 335, a tester channel is set up for each processor unit and in steps 340A-340N, 345A-245N and 350A-350N the processor units are tested in parallel though the sorts are still applied in sequentially. In FIG. 3B, steps 340A through 340N are identical to one another and to step 305 of FIG. 3A. Steps 345A through 345N are identical to one another and to step 310 of FIG. 3A. Steps 350A through 350N are identical to one another and to step 320 of FIG. 3A. Step 355 is identical to step 325 of FIG. 3A and step 360 is identical to step 330 of FIG. 3A.

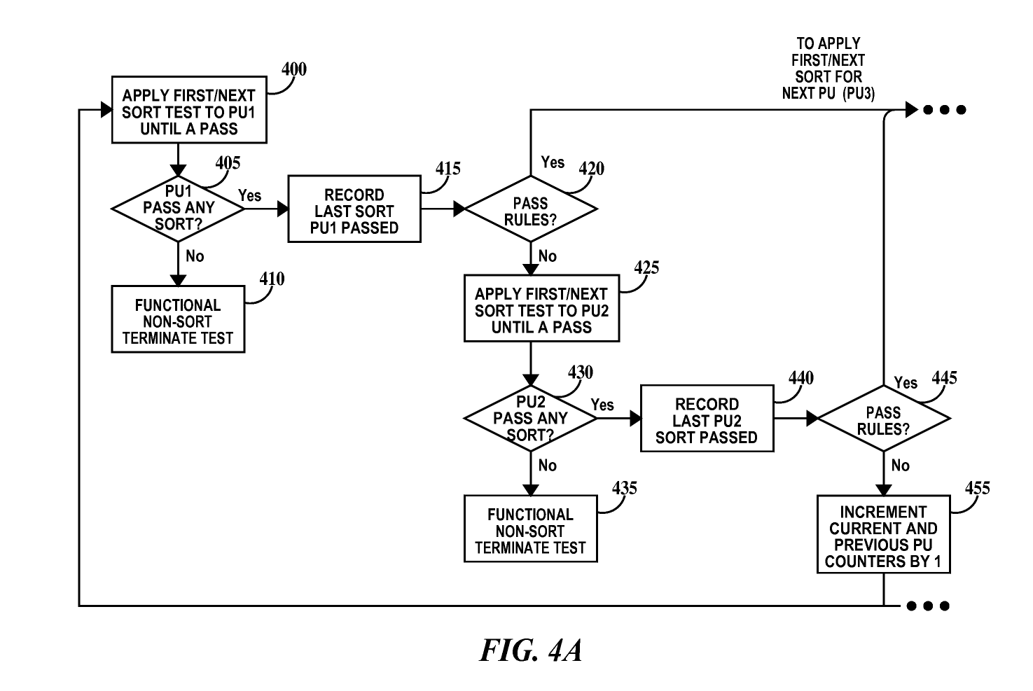

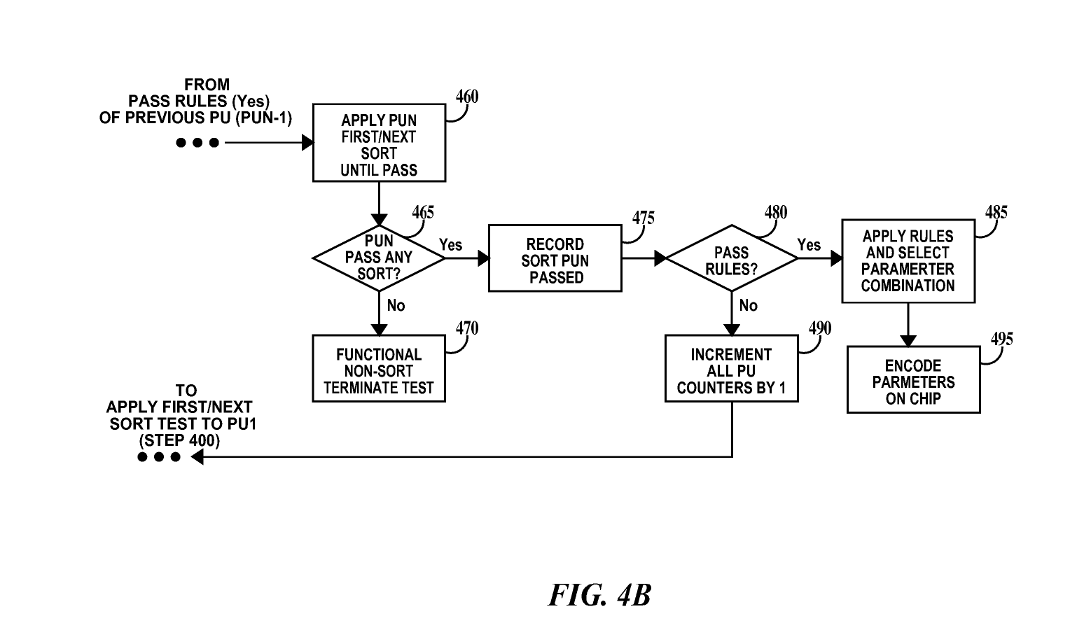

FIGS. 4A and 4B are a flow diagram of a third method of testing an multi-processor unit microprocessor. In FIGS. 4A and 4B, N processor units are assumed. In step 400, the first processor unit (PU1) is tested with the first/next sort test (based on a PU1 sort test counter value) until a sort is passed or no further sort tests are left. In step 405, it is determined if the first processor unit has passed any sort test. If no sort test has been passed, in step 410, the microprocessor is designated a functional non-sort part and the testing and sorting is terminated. If in step 405, it is determined that the first processor unit has passed any sort test, then in step 415, the sort test parameters of the passed sort test are added to a table similar to table II discussed supra and the method proceeds to step 420.

On the first pass through step 420, the rules are not applied and the method goes directly to step 425 because the rules can be applied only when two or more processor units have each been sort tested and each has passed at least one sort test. However, in any step where rules are applied, the rules are applied to all current entries of table II. Assuming a second or subsequent pass through step 420, rules from a table similar to table III discussed supra are applied.

If in step 420, any rule is passed the method proceeds to testing the next processor unit (PU 3), if in step 420, no rule is passed, then in step 425, the second processor unit (PU2) is tested with the first/next sort test (based on a PU2 sort test counter value) until a sort is passed or no further sort tests are left. In step 430, it is determined if the second processor unit has passed any sort test. If no sort test has been passed, in step 435, the microprocessor is designated a functional non-sort part and the testing and sorting is terminated. If in step 430, the second processor unit has passed a sort test, then in step 440, the sort test parameters are recorded in a table similar to Table II discussed supra and the method proceeds to step 445.

If in step 445, any rule is passed the method proceeds to testing the next processor unit (PU 3), if not then in step 455 all sort test counters of the current and previously tested processor units are incremented by one and the method loops to step 400. (In step 455, the counters for PU1 and PU2 are incremented). Testing, sorting and looping of processor units PU 3 to the next to last processor unit (PUN-1) are similar to testing the second processor unit. The flow diagram of FIG. 4A is continued in FIG. 4B.

Skipping to testing the last processor unit (PUN), in step 460, the last processor unit (PUN) is tested with the first/next sort test (based on a PUN sort test counter value) until a sort is passed or no further sort tests are left. In step 465, it is determined if the last processor unit (PUN) has passed any sort test. If no sort test has been passed, in step 470, the microprocessor is designated a functional non-sort part and the testing and sorting is terminated. If in step 465, the last processor unit has passed a sort, then in step 475, the sort test parameters are recorded in a table similar to Table II discussed supra and the method proceeds to step 480.

If in step 480, any rule is passed the method proceeds to step 485, if not then in step 490 all sort test counters (PU1 through PUN) are incremented by one and the method loops to step 400. In step 485, the rules are again applied to the cumulative passed sort tests recorded in Table II and a parameter combination for each processor unit that optimizes the goal of the sort testing is selected as described supra in reference to step 325 of FIG. 3A. In optional step 495, codes indicating the parameters for each processor unit are encoded into the fuse bank(s) (see FIGS. 1A and 1B) of the microprocessor. In subsequent module processing or packaging operations, the parameters required for each processor unit may be encoded in fuse banks contained in the microprocessor, if they were not encoded in optional step 495, and/or they may be printed on the microprocessor module.

The method described in FIGS. 4A and 4B potentially saves tester time since sort testing of a particular processor unit is stopped when the particular processor unit has passed a sort and only resumes if when no acceptable combination of all the processor tested to the current point in time is found.

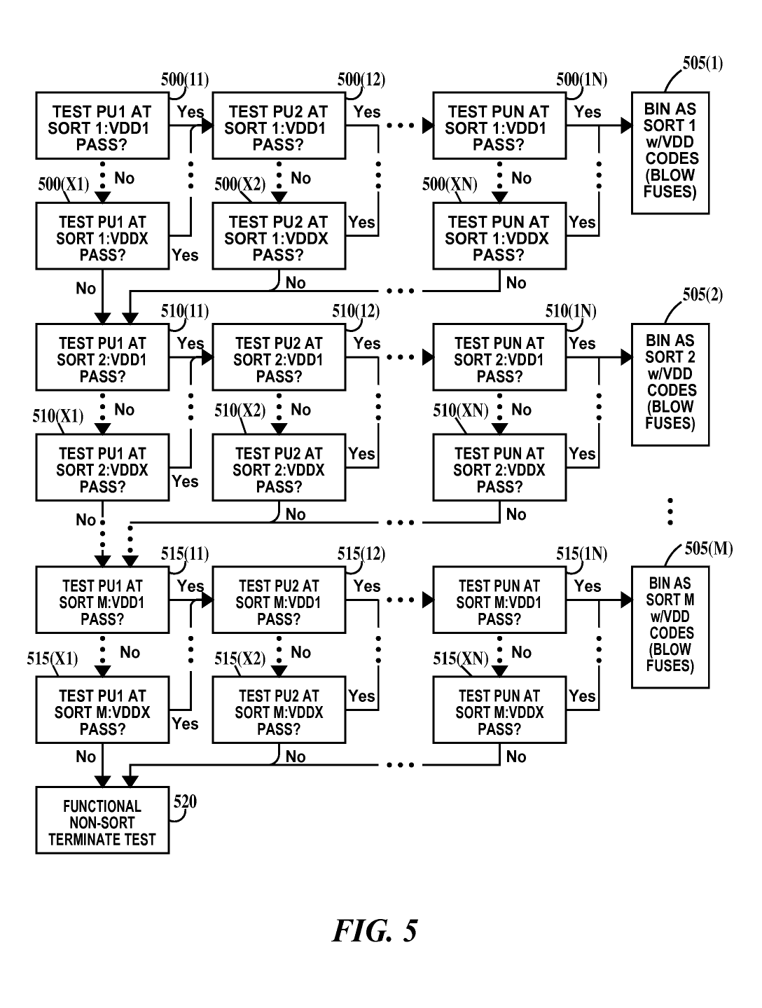

A further decrease in tester time may be accomplished by “hard coding” the rules into the method flow and by selection and positioning of the sort tests themselves within the method flow as illustrated in FIG. 5 and described infra.

FIG. 5 is a flow diagram of a fourth method of testing an multi-processor unit microprocessor. The flow diagram of FIG. 5 should be considered as exemplary of the fourth method. The method illustrated in FIG. 5 should be considered exemplary of the fourth method. In FIG. 5, the fourth method is described using only the voltage parameter VDD as the varied parameter within a sort test, the parameters of temperature, operating frequency and power vary from sort to sort but are constant with a given sort. It should be understood that any of the sort parameters of temperature, power, operating frequency and voltage (or combinations thereof) may be varied within a sort while the other parameters are held constant within the sort.

In FIG. 5, a microprocessor including N processor units is assumed and there are M sort tests using X VDD values (the externally supplied operating voltage). In step 500(11), the first processor unit (PU1) is tested with the first sort (SORT 1) conditions against the first VDD value (VDD1). If the processor passes the test, then the method proceeds to step 500(12). Steps 500(11), 500(X1), 500(1N) and 500(XN) may be considered the corners of an array of potential tests for a SORT 1 test matrix. A first column of the array is defined by steps 500(11) through 500(X1) and a last column of the array is defined by steps 500(1N) through 500(XN). A first row of the array is defined by steps 500(11) through 500(1N) and a last row of the array is defined by steps 500(X1) through 500(XN). Each of the steps 500(11) through 500(1N) performs a SORT 1 test using VDD1 on a different processor unit and each of steps 500(X1)through 500(XN) performs a SORT 1 test using VDDX on a different processor unit.

The steps in the first row of the array are performed in sequence with an immediate branch to the step in the first row of the next column in the event a test in any step of the column is passed. In the last column of the array an immediate branch to step 505(1) occurs the event any test in the last column of the array is passed. Upon a pass of a test in the array, the VDD value and processor unit is recorded. In step 505(1) the microprocessor is designated as a sort 1 part number (P/N) (BIN is shorthand for P/N bin) with separate VDD codes indicating the pass VDD value of each processor. Optionally the power supply voltage levels required for each processor unit may be encoded in fuse banks contained in the microprocessor. In subsequent module processing or packaging operations, the power supply voltage levels required for each processor unit may be encoded in fuse banks contained in the microprocessor, if they were not encoded in step 505(1), and/or they may be printed on the microprocessor module. In the event any test in the last row of the array is not passed an immediate branch to step 510(11) is performed. A fail in step 500(X1) also causes a branch to step 510(11).

A SORT 2 matrix is defined by the corner steps 510(11), 510(X1), 510(1N) and 510(XN). In step 510(11), the first processor unit (PU1) is tested with the second sort (SORT 2) conditions against the first VDD value (VDD1). If the processor passes the test, then the method proceeds to step 510(12). Steps 510(11), 510(X1), 510(1N) and 51 0(XN) may be considered the corners of an array of potential tests. A first column of the array is defined by steps 510(11) through 510(X1) and a last column of the array is defined by steps 510(1N) through 510(XN). A first row of the array is defined by steps 510(11) through 510(1N) and a last row of the array is defined by steps 510(X1) through 510(XN). Each of the steps 510(11) through 510(1N) performs a SORT 2 test using VDD1 on a different processor unit and each of steps 510(X1)through 510(XN) performs a SORT 2 test using VDDX on a different processor unit. Movement between steps in the SORT 2 matrix is similar to that described for the SORT 1 matrix supra.

A SORT M matrix is defined by the corner steps 515(11), 515(X1), 515(1N) and 515(XN). In step 515(11), the first processor unit (PU1) is tested with the Mth sort (SORT M) conditions against the first VDD value (VDD1). If the processor passes the test, then the method proceeds to step 515(12). Steps 515(11), 515(X1), 515(1N) and 515(XN) may be considered the comers of an array of potential tests. A first column of the array is defined by steps 515(11) through 515(X1) and a last column of the array is defined by steps 515(1N) through 515(XN). A first row of the array is defined by steps 515(11) through 515(1N) and a last row of the array is defined by steps 515(X1) through 515(XN). Each of the steps 515(11) through 515(1N) performs a SORT M test using VDD 1 on a different processor unit and each of steps 515 (X1 )through 515(XN) performs a SORT M test using VDDX on a different processor unit. Movement between steps in the SORT M matrix is similar to that described for the SORT 1 matrix supra except that a no from any of steps 515(X1) through 515 (XN) causes a branch to step 520.

If step 520 is reached, no combination of VDDs results in a passed sort and the microprocessor is designated a functional non-sort part and the testing and sorting is terminated.

The arrays of potential tests between the SORT 2 matrix and the SORT M matrix are not shown, but indicated by the three dots between steps 510(X1) and 510(X2). In order to avoid repeating the same sort/processor unit/VDD test combination, the sorts and VDD value a processor unit passes may be tracked and the flow through each of the N times X times M potential test arrays adjusted automatically based on earlier test results on the microprocessor to avoid repeating identical tests.

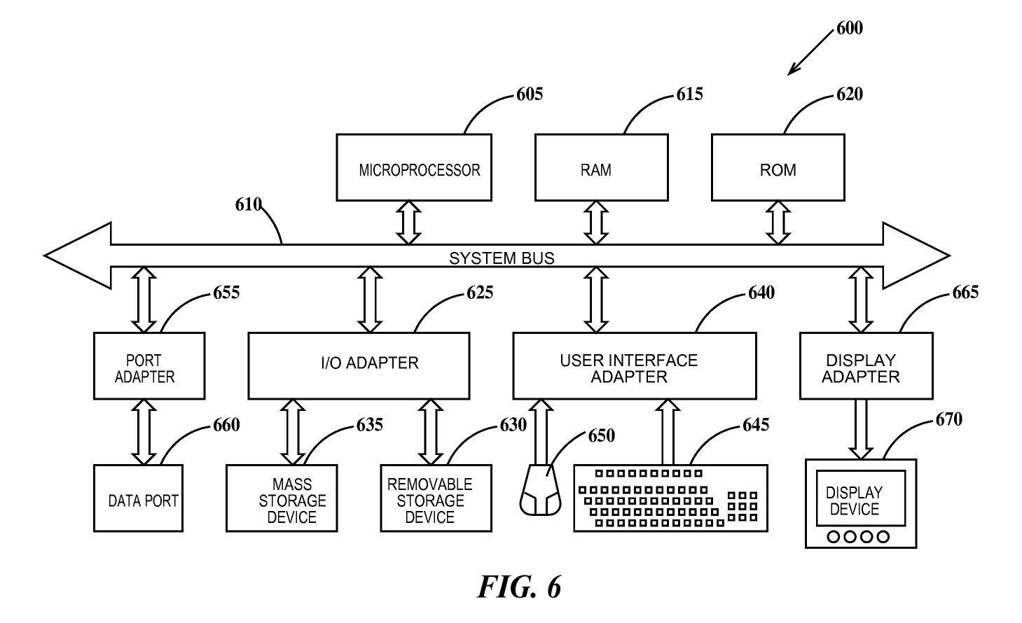

FIG. 6 is a schematic block diagram of a general-purpose computer portion of a tester for practicing the present invention. Generally, the method described herein with respect to testing a multi-processor unit microprocessor is practiced with a general-purpose computer linked to or included in a test system and the methods described supra in the flow diagrams of FIGS. 3A, 3B, 4A, 4B and 5 may be coded as a set of instructions on removable or hard media for use by the general-purpose computer.

FIG. 6 is a schematic block diagram of a general-purpose computer that may be included in a test system for practicing the present invention. In FIG. 6, computer system 600 has at least one microprocessor or central processing unit (CPU) 605. CPU 605 is interconnected via a system bus 610 to a random access memory (RAM) 615, a read-only memory (ROM) 620, an input/output (I/O) adapter 625 for a connecting a removable data and/or program storage device 630 and a mass data and/or program storage device 635, a user interface adapter 640 for connecting a keyboard 645 and a mouse 650, a port adapter 655 for connecting a data port 660 and a display adapter 665 for connecting a display device 670.

ROM 620 contains the basic operating system for computer system 600. The operating system may alternatively reside in RAM 615 or elsewhere as is known in the art. Examples of removable data and/or program storage device 630 include magnetic media such as floppy drives and tape drives and optical media such as CD ROM drives. Examples of mass data and/or program storage device 635 include electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. In addition to keyboard 645 and mouse 650, other user input devices such as trackballs, writing tablets, pressure pads, microphones, light pens and position-sensing screen displays may be connected to user interface 640. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 630, fed through data port 660 or typed in using keyboard 645.

Thus, the embodiments of the present invention provide a method to guarantee that a microprocessor's performance and heating are optimized across the integrated circuit chip.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. A method, comprising:
(a) selecting and testing, with a selected parameter set of a group of parameter sets, a processor unit of a microprocessor having two or more processor units;
(b) comparing the operation of said selected processor unit to a selected specification of a set of operational specifications of said microprocessor;
(c) if said testing indicates that the operation of said selected processor unit does not meet said selected specification, repeating (a) and (b) with a different parameter set of said group of parameter sets until either said selected processor unit meets said selected specification or all parameter sets of said group of parameter sets have been selected; and
(d) if said testing indicates that the operation of said selected processor unit does meet said selected specification, repeating (a), (b) and (c) until all processor units of said two or more processor units of said microprocessor have been selected.

2. The method of claim 1, further including:
(e) if all of said processor units of said two or more processor units of said microprocessor meet said specification, assigning an identifier to said microprocessor, said identifier indicating which parameter set of said group of parameter sets resulted in each processor unit of said two or more processor units of said microprocessor meeting said specification.

3. The method of claim 1, further including:
(e) if all of said processor units of said two or more processor units of said microprocessor meet said specification, assigning an identifier to said microprocessor, said identifier indicating which parameter set of said group of parameter sets resulted in each processor unit of said two or more processor units of said microprocessor meeting said specification; and
(f) blowing fuses of a fuse bank of said microprocessor in order to encode said identifier into said microprocessor.

4. The method of claim 1, further including:
(e) selecting a different specification of said set of operational specifications and repeating (a), (b), (c) and (d) until all processor units of said two or more processor units of said microprocessor have been selected.

5. The method of claim 4, further including:
(f) if all of said processor units of said two or more processor units of said microprocessor meet said specification, assigning an identifier to said microprocessor, said identifier indicating which parameter set of said group of parameter sets resulted in each processor unit of said two or more processor units of said microprocessor meeting said specification.

6. The method of claim 4, further including:
(f) if all of said processor units of said two or more processor units of said microprocessor meet said specification, assigning an identifier to said microprocessor, said identifier indicating which parameter set of said group of parameter sets resulted in each processor unit of said two or more processor units of said microprocessor meeting said specification; and
(g) blowing fuses of a fuse bank of said microprocessor in order to encode said identifier into said microprocessor.

7. The method of claim 1, wherein said parameter sets include parameters selected from the group consisting of operating voltages of said two or more processor units, operating frequencies of said two or more processor units, operating temperatures of said two or more processor unit, power consumptions of said two or more processor units and combinations thereof.

8. The method of claim 1, wherein said specification sets include specifications selected from the group consisting of specified operating voltage ranges of said two or more processor units, specified operating frequency ranges of said two or more processor units, specified operating temperature ranges of said two or more processor units, specified power consumption ranges of said two or more processor units and combinations thereof.

9. The method of claim 1, wherein each processor unit is a voltage island and further including independently assigning each processor unit an operating voltage.

10. The method of claim 9, wherein each operating voltage of each processor unit is selected to match power consumption, operating temperature, operating frequency or combinations thereof of each processor unit to one another.

11. A computer program product, comprising a computer usable medium having a computer readable program code embodied therein, said computer readable program code comprising an algorithm adapted to implement a method for testing and sorting a microprocessor having two or more processor units, said method comprising the steps of:
(a) selecting and testing, with a selected parameter set of a group of parameter sets, a processor unit of a microprocessor having two or more processor units;
(b) comparing the operation of said selected processor unit to a selected specification of a set of operational specifications of said microprocessor;
(c) if said testing indicates that the operation of said selected processor unit does not meet said selected specification, repeating (a) and (b) with a different parameter set of said group of parameter sets until either said selected processor unit meets said selected specification or all parameter sets of said group of parameter sets have been selected; and
(d) if said operation of said selected processor unit does meet said selected specification, repeating (a), (b) and (c) until all processor units of said two or more processor units of said microprocessor have been selected.

12. The computer program product of claim 11, the method further including the step of:
(e) if all of said processor units of said two or more processor units of said microprocessor meet said specification, assigning an identifier to said microprocessor, said identifier indicating which parameter set of said group of parameter sets resulted in each processor unit of said two or more processor units of said microprocessor meeting said specification.

13. The computer program product of claim 11, the method further including the step of:
(e) selecting a different specification of said set of operational specifications and repeating (a), (b), (c) and (d) until all processor units of said two or more processor units of said microprocessor have been selected.

14. The computer program product of claim 13, the method further including the step of:
(f) if all of said processor units of said two or more processor units of said microprocessor meet said specification, assigning an identifier to said microprocessor, said identifier indicating which parameter set of said group of parameter sets resulted in each processor unit of said two or more processor units of said microprocessor meeting said specification.

15. The computer program product of claim 11, wherein said parameter sets include parameters selected from the group consisting of operating voltages of said two or more processor units, operating frequencies of said two or more processor units, operating temperatures of said two or more processor units, power consumptions of said two or more processor units and combinations thereof.

16. The computer program product of claim 11, wherein said specification sets include specifications selected from the group consisting of specified operating voltage ranges of said two or more processor units, specified operating frequency ranges of said two or more processor units, specified operating temperature ranges of said two or more processor units, specified power consumption ranges of said two or more processor units and combinations thereof.

17. The computer program product of claim 11, wherein each processor unit is a voltage island and the method further including independently assigning each processor unit an operating voltage.

18. The computer program product of claim 17, further including the method step of selecting each operating voltage of each processor unit to match power consumptions of each processor unit to one another, operating temperatures of each processor unit to one another, operating frequencies of each processor unit to one another or combinations thereof.

19. A microprocessor, comprising:
two or more processor units, each processor unit comprising a voltage island; and
a fuse bank in said microprocessor, said fuse bank encoding, independently for each processor unit of said two or more processor units, at least one operating parameter for each of said processor units of said two or more processor units.

20. The microprocessor of claim 19, wherein said at least one operating parameter is an a external power supply voltage level to be electrically connected to a power grid of each of said processor units.
